(19) United States
(12) Patent Application Publication
(10) Pub. No.: US 2021/0116076 A1
(43) Pub. Date: Apr. 22, 2021

(54) ANOMALY DETECTION IN PIPELINES AND FLOWLINES

(71) Applicant: EOG Resources, Inc., Houston, TX (US)

(72) Inventors: Justin Alan Ward, Houston, TX (US); Alexey Lukyanov, Houston, TX (US); Ashley Sean Kessel, Bellaire, TX (US); Alexander P. Jones, Houston, TX (US); Bradley Bennett Burt, Corpus Christi, TX (US); Nathan Rice, Durham, NC (US)

(21) Appl. No.: 17/077,670

(22) Filed: Oct. 22, 2020

Related U.S. Application Data
(60) Provisional application No. 62/924,457, filed on Oct. 22, 2019.

(51) Int. Cl. F17D 5/06; F17D 3/18; G06N 20/00

(52) U.S. Cl. CPC F17D 5/06; F17D 3/01; G06N 20/00; F17D 3/18

(57) ABSTRACT

Method and systems for detecting an anomaly in a pipeline or a flowline. The method includes monitoring real-time data in the pipeline or the flowline, wherein the pipeline or flowline includes a plurality of nodes, the nodes including at least one or more inlets and one or more outlets. The method includes generating a probability metric using a prediction service, wherein the prediction service uses a convolutional neural network. The method includes determining whether to add an alarm, based, at least in part on the probability metric and if there are one or more active alarms, performing an action based on the active alarm.

### CROSS-REFERENCE TO RELATED APPLICATION

This application claims priority to U.S. Provisional Application No. 62/924,457 filed Oct. 22, 2019 entitled “Anomaly Detection in Pipelines and Flowlines” by Justin Alan Ward, Alexey Lukyanov, Ashley Sean Kessel, Alexander P. Jones, Bradley Bennett Burt, and Nathan Rice.

### BACKGROUND

Fluids, such a water or hydrocarbons may be moved over distances using pipelines or flowline. In general, flowlines refer to conveyances for fluids a single site and pipelines refer to fluid conveyances over greater distances. Anomalies may develop in both pipelines and flowlines. Existing anomaly detection systems for pipelines and flowlines are generally based on fluid modeling and suffer from both too many false positives and false negatives. Existing pipeline leak-detection systems are, in general, loosely integrated, disparate systems in the enterprise. Furthermore, existing pipeline leak-detection systems have high administration and engineering support costs. Furthermore, existing pipeline leak-detection systems are technology dependent and are generally limited to a real-time transient model (RTTM) for features related to leak size and leak localization. Flowline leak detection systems are a nonexistent in commercially available solution.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A-1D illustrate example pipelines of the present disclosure;

FIGS. 2A-2H illustrate example flowlines of the present disclosure;

FIG. 3 illustrates a block diagram of an exemplary control system of the present disclosure; and

FIGS. 4-12 are block diagram of an exemplary anomaly detection systems.

FIG. 13 is a chart showing well production decline.

FIGS. 14 and 15 are graphs of node pressures versus time.

FIG. 16 is a flowchart of an example process for static pressure analysis and anomaly detection.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For the purposes of this disclosure, computer-readable media may include any instrumentality or aggregation of instrumentalities that may retain data and/or instructions for a period of time. Computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

Illustrative embodiments of the present invention are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming, but would nevertheless be a routine undertaking for those of ordinary skill in the art having the benefit of the present disclosure.

To facilitate a better understanding of the present invention, the following examples of certain embodiments are given. In no way should the following examples be read to limit, or define, the scope of the invention. The terms “couple” or “couples,” as used herein are intended to mean either an indirect or a direct connection. Thus, if a first device couples to a second device, that connection may be through a direct connection, or through an indirect electrical connection via other devices and connections. Similarly, the term “communicatively coupled” as used herein is intended to mean either a direct or an indirect communication connection. Such connection may be a wired or wireless connection such as, for example, Ethernet or LAN. Thus, if a first device communicatively couples to a second device, that connection may be through a direct connection, or through an indirect communication connection via other devices and connections.

The present disclosure includes methods, systems, and software to perform anomaly detection in pipeline or flowlines. Fluids in both pipeline and flowlines may include one or both of turbulent (for example, non-steady state) and laminar flow. In certain example implementations, pipelines includes one or more inlets and one or more outlets. In certain example implementations, flowline leak detection is a single inlet to multiple outlet streams on the separation vessel(s) or to the product processing facility. Other example factors that influence pipeline flow characteristics are elevation deviations, which can contribute to increased transient volumes. In certain example implementations, a well's flowline typically has differing qualities of gas-to-liquid ratio (GLR), which contribute to the non-steady state and are also impacted by one or more of pipe diameter, inclination, and/or elevation.

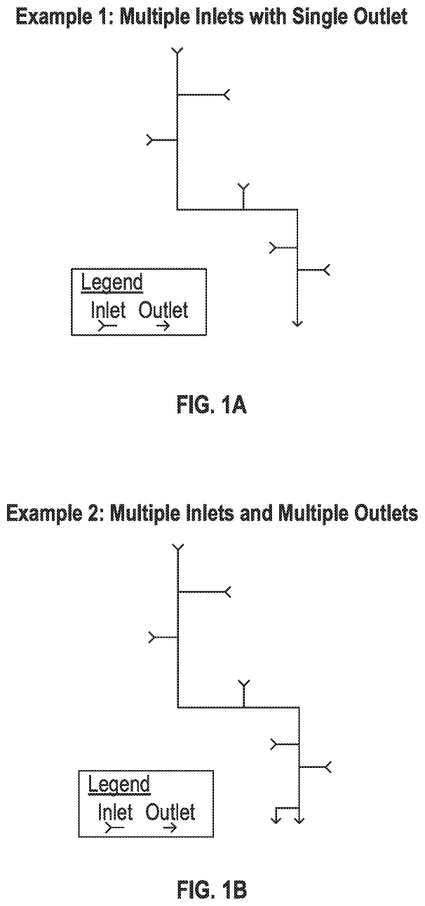

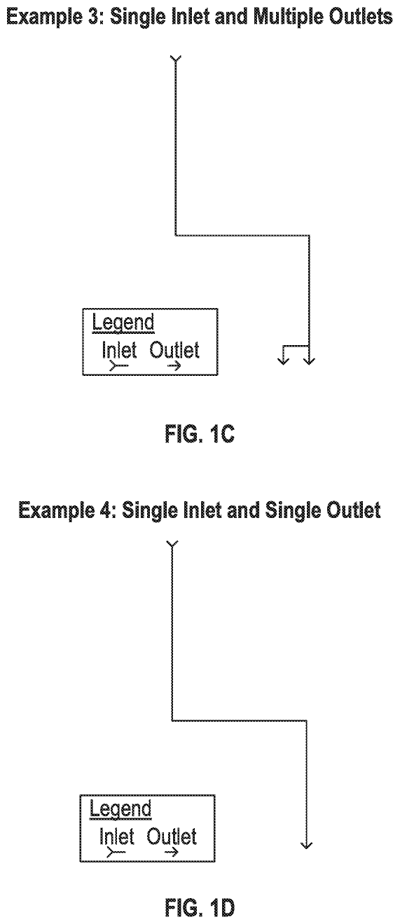

FIGURES TA, 1B, 1C, and 1D are diagrams of example pipelines according to the present disclosure. The pipeline of FIGURE TA has multiple inlets with a single outlet. The pipeline of FIG. 1B has multiple inlets with multiple outlets. The pipeline of FIG. 1C has a single inlet and multiple outlets. The pipeline of FIG. 1D has a single inlet and a single outlet. In general, example pipelines have one or more inlets and outlets. One or more sensors may be used to monitor the pipeline. In certain example embodiments, one or more pressures are measured at locations in the pipeline. In certain example embodiments, one or more flow rates are measured at locations in the pipeline. In certain example embodiments, one or more temperatures are measured at locations in the pipeline. Certain example embodiments further use one or more acoustic or visual sensors to monitor one or more locations in the pipeline. Other example sensors include lasers, smart pigs, and infrared/non-visual spectrum cameras. The pipeline of FIGURE TA has multiple inlets with a single outlet. The pipeline of FIG. 1B has multiple inlets with multiple outlets. The pipeline of FIG. 1C has a single inlet and multiple outlets. The pipeline of FIG. 1D has a single inlet and a single outlet.

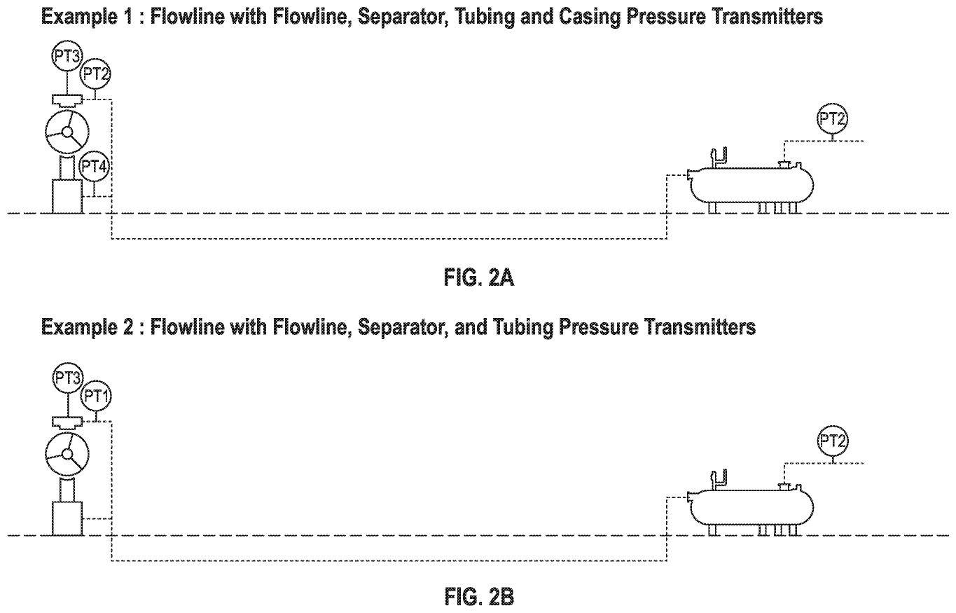

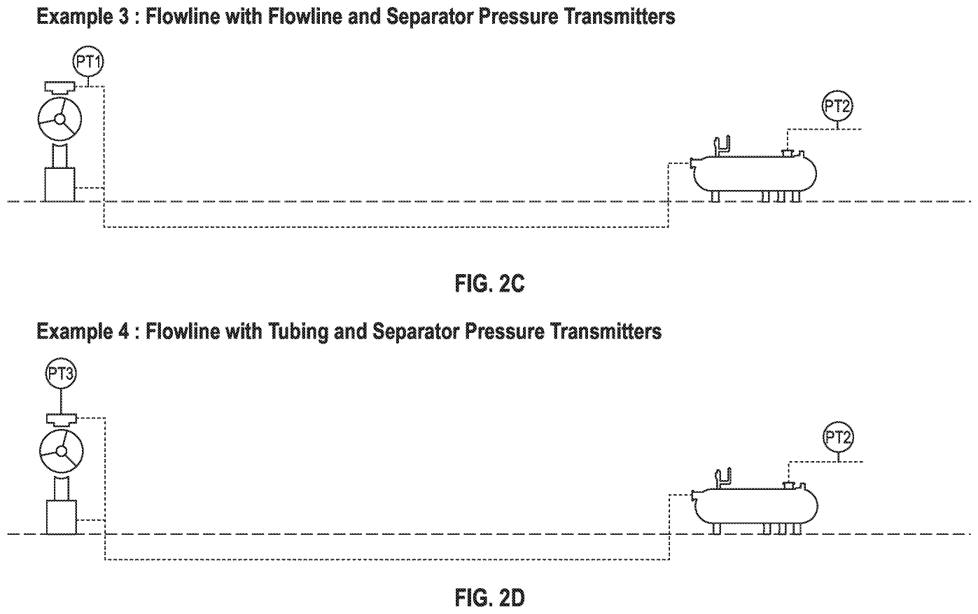

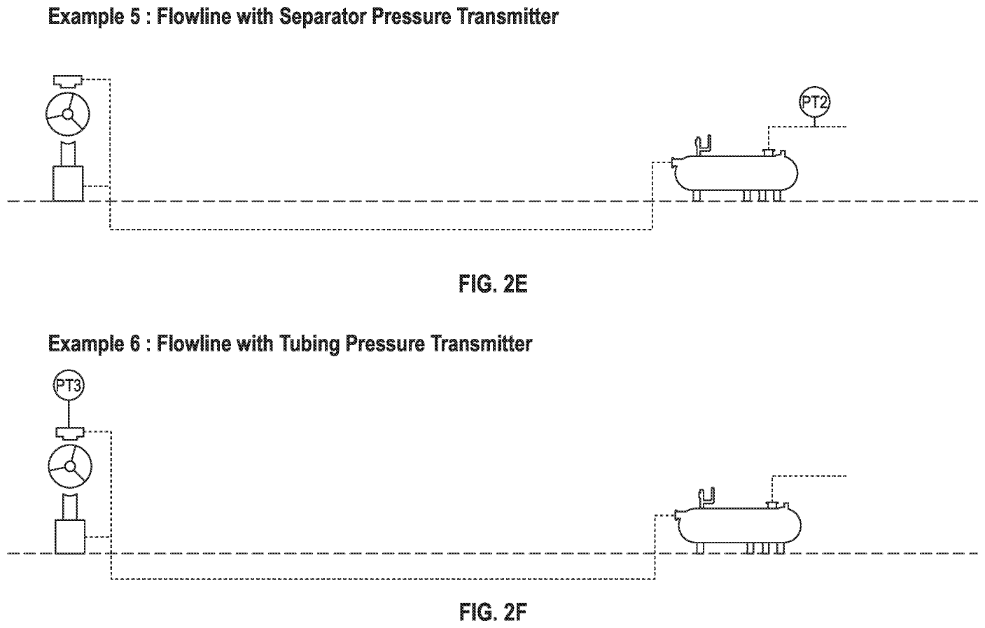

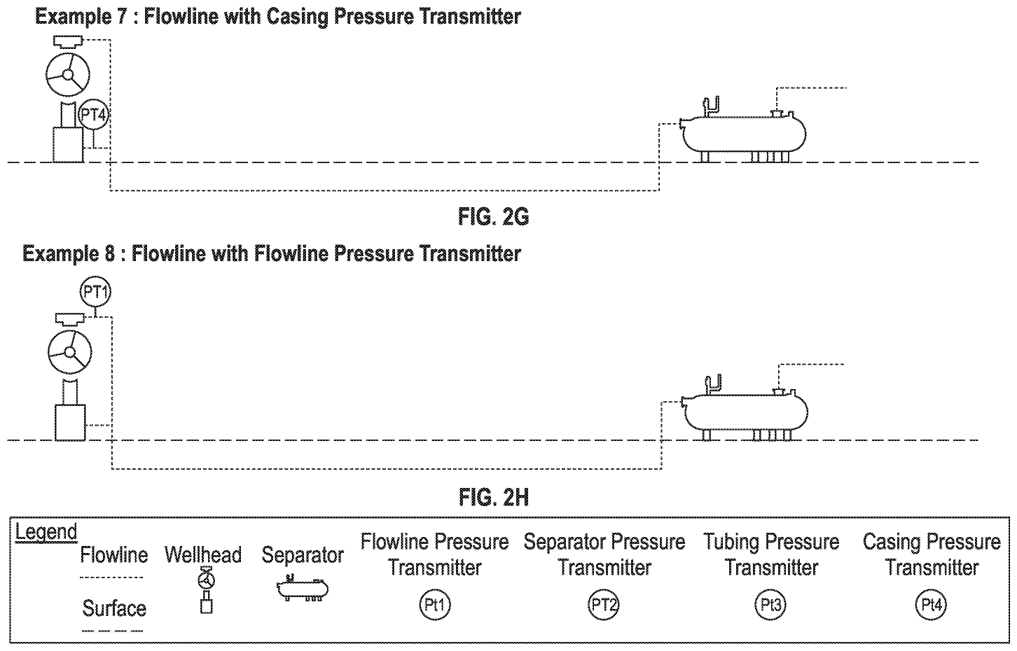

FIGS. 2A, 2B, 2C, 2D, 2E, 2F, 2G, and 2H are diagrams of example flow lines according to the present disclosure. FIG. 2A is an example flow line system with a wellhead, a flowline, a separator, tubing, separator pressure transmitters (PT2), tubing pressure transmitter (PT3), and a casing pressure transmitter (PT4). FIG. 2B is an example flow line system with a wellhead, a flowline, a separator, tubing, a flowline pressure transmitter (PT1), a separator pressure transmitter (PT2), a tubing pressure transmitter (PT3), and a casing pressure transmitter (PT4). FIG. 2B is an example flow line system with a wellhead, a flowline, a separator, tubing, a flowline pressure transmitter (PT1), a separator pressure transmitter (PT2), and a tubing pressure transmitter (PT3). FIG. 2C is an example flow line system with a wellhead, a flowline, a separator, tubing, a flowline pressure transmitter (PT1) and a separator pressure transmitter (PT2). FIG. 2D is an example flow line system with a wellhead, a flowline, a separator, tubing, a separator pressure transmitter (PT2) and a tubing pressure transmitter (PT3). FIG. 2E is an example flow line system with a wellhead, a flowline, a separator, tubing, and a separator pressure transmitter (PT2). FIG. 2F is an example flow line system with a wellhead, a flowline, a separator, tubing, and a tubing pressure transmitter (PT3). FIG. 2G is an example flow line system with a wellhead, a flowline, a separator, tubing, and a casing pressure transmitter (PT4). FIG. 2H is an example flow line system with a wellhead, a flowline, a separator, tubing, and a flowline pressure transmitter (PT1). In general, example flow line systems have one or more inlets and outlets. One or more sensors may be used to monitor the pipeline and flowlines. Example flowline systems include one or more flowline pressure transmitters (PT1), separator pressure transmitters (PT2), tubing pressure transmitters (PT3), and a casing pressure transmitters (PT4). In certain example embodiments, one or more pressures are measured at locations in the pipeline. In certain example embodiments, one or more flow rates are measured at locations in the pipeline. In certain example embodiments, one or more temperatures are measured at locations in the pipeline. Certain example embodiments further use one or more acoustic or visual sensors to monitor one or more locations in the pipeline.

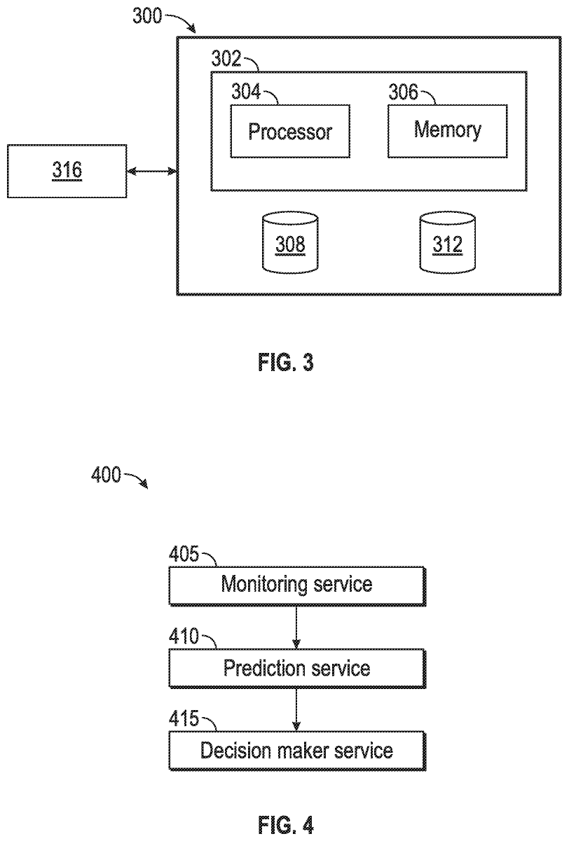

FIG. 3 illustrates a block diagram of an exemplary control unit 300 in accordance with some embodiments of the present disclosure. In certain example embodiments, control unit 300 may be configured to create and maintain a first database 308 that includes one information concerning one or more pipelines or flowlines. In other embodiments the control unit is configured to create and maintain databases 308 with information concerning one or more pipeline or flowlines. In certain example embodiments, control unit 300 is configured to use information from database 308 to train one or many machine learning algorithms 312, including, but not limited to, artificial neural network, random forest, gradient boosting, support vector machine, or kernel density estimator. In some embodiments, control system 302 may include one more processors, such as processor 304. Processor 304 may include, for example, a microprocessor, microcontroller, digital signal processor (DSP), application specific integrated circuit (ASIC), or any other digital or analog circuitry configured to interpret and/or execute program instructions and/or process data. In some embodiments, processor 304 may be communicatively coupled to memory 306. Processor 304 may be configured to interpret and/or execute non-transitory program instructions and/or data stored in memory 306. Program instructions or data may constitute portions of software for carrying out anomaly detection, as described herein. Memory 306 may include any system, device, or apparatus configured to hold and/or house one or more memory modules; for example, memory 306 may include read-only memory, random access memory, solid state memory, or disk-based memory. Each memory module may include any system, device or apparatus configured to retain program instructions and/or data for a period of time (e.g., computer-readable non-transitory media).

Although control unit 300 is illustrated as including two databases, control unit 300 may contain any suitable number of databases and machine learning algorithms.

Control unit 300 may be communicatively coupled to one or more displays 316 such that information processed by sensor control system 302 may be conveyed to operators at or near the pipeline or flowline or may be displayed at a location offsite.

Modifications, additions, or omissions may be made to FIG. 3 without departing from the scope of the present disclosure. For example, FIG. 3 shows a particular configuration of components for control unit 300. However, any suitable configurations of components may be used. For example, components of control unit 300 may be implemented either as physical or logical components. Furthermore, in some embodiments, functionality associated with components of control unit 300 may be implemented in special purpose circuits or components. In other embodiments, functionality associated with components of control unit 300 may be implemented in a general purpose circuit or components of a general purpose circuit. For example, components of control unit 300 may be implemented by computer program instructions.

FIG. 4 is a block diagram of a method of anomaly detection for a pipeline or flowline. In block 405, the control unit performs a monitoring service. In block 410, the control unit performs a prediction service. In block 415, the control unit performs a decision-making service. In embodiments of the present disclosure, one or more of blocks 405-415 may be omitted, repeated, or preformed in a different order.

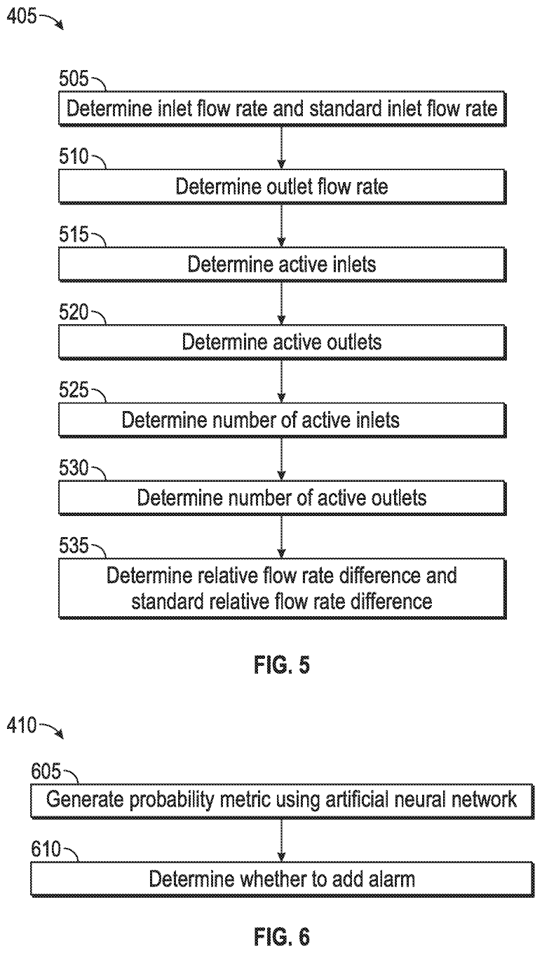

An example monitoring service (block 405) is shown in greater detail in FIG. 5. The example monitoring service of FIG. 5 is based on flow rates. In general, however, the control unit 300 monitors real-time data concerning the pipeline or the flowline. In certain example embodiments the real-time data in the pipeline or the flowline includes one or more of pressures, flow rates, temperatures, acoustics, vibration, visual data, and multispectral imaging data. The one or more pressures, flow rates, temperatures, acoustics, vibration, and visual data are generated by sensors. The real-time data is generated by one or more sensors and provided to control until 300. The control unit determines inlet flow rate and standard inlet flow rates (block 505). In certain example embodiments, the inlet flow rate is calculated as a sum of flow rates from all active inlets. This may represent the total volume of fluid added to the system of the pipeline or flowline in a given period of time.

The control unit determines outlet flow rates (block 510). In certain example embodiments, the outlet flow rate is calculated as a sum of flow rates from all active outlet. This may represent the total volume of fluid removed from the system of the pipeline or flowline in a given period of time. One or more of inlet and outlet flow rates may be standardized to 60° F. and 1 atmosphere of pressure.

The control unit determines a listing of active inlets (block 515) and a number of active inlets (block 525). The control unit determines a listing of active outlets (block 520) and a number of active outlets (block 530). In certain example embodiments, the listing of inlets and outlets generates a listing of (primo, metric) for the instance where multiple LACTs have the same primo, but different metrics.

The control unit then determines a relative flow rate and/or a standard relative flow rate difference (block 535). In embodiments of the present disclosure, one or more of blocks 505-535 may be omitted, repeated, or preformed in a different order. In one example embodiment, the monitoring service 405 runs in an infinite loop and waits five seconds between iterations. The delay may be based, in part, on the time for sensor data to be transmitted to and ingested into the database 308. In other example embodiments, the monitoring service loops more frequently. In other example embodiments, the monitoring service loops less frequently. In certain embodiments, the delay between iterations is based on how frequently sensors collect the data. In certain embodiments, algorithm iteration takes less than 1 second, data come from sensors with period equal to 5 seconds.

An example prediction service (block 410) is shown in FIG. 6. The control unit generates a plurality of probability metrics using a trained machine learning algorithm (block 605). Generated probability metrics include, but are not limited to, original probability value generated by the trained machine learning algorithm, moving average probability over the last N iterations, weighted moving average probability over the last N iterations. In certain example embodiments, one or more of the probability metrics (or all of the probability metrics) are normalized to be between 0 and 1. The system then determines whether to add an alarm based, at least in part, on one of the probability metrics (block 610). In certain example embodiments, the probability metric must be above a minimum leak probability threshold for longer than a minimum warning mode threshold time before an alarm is added. In one example embodiment, the minimum leak probability threshold is 0.5. In other example embodiments, the minimum leak probability threshold is 0.1, 0.2, 0.3, 0.4, 0.6, 0.7, 0.8, 0.9, or 1 or another value between 0 and 1. In one example embodiment, the minimum warning mode threshold time is 2 minutes. In other embodiments, the minimum warning mode threshold time is 30 second, 1 minute, 3 minutes, 4 minutes, 5 minutes, 6 minutes, 7 minutes, 8 minutes, 9 minutes, or 10 minutes. In general, the minimum warning mode threshold time is chosen so that transitory but non-anomalous events in the pipeline or flowline do not trigger false alarms. On the other hand, the minimum warning mode threshold time is set so that actual anomalies are promptly reported so that actions can be taken. In certain embodiments, the warning mode is triggered after the probability metric exceeds a defined threshold. If the probability metric remains above that threshold for a predefined amount of time, then the warning mode transforms to an alarm. Example amount of times for a warning to transform to an alarm include 10, 20, 30, 40, 50, 60, 70, 80, 90, 100, 110, 120, 130, 140, 150, 160, 170, 180, 190, 200, 210, 220 and 140 seconds.

An example training method for the prediction service (block 410) is shown in FIG. 12. The example training method is shown generally at 1200. The control unit receives and labels data (block 1205). In certain example embodiments, the control receives raw unlabeled data from one or more sensors. In certain embodiments, each data point at given time is characterized as good data (for example, indicative of no leak) or bad data (for example, indicative of a leak). To train a machine learning model (Neural Network, Random Forest, XGB, etc.), the controller creates a data set where each data point is associated with a label—a number that says whether we have a leak or not. In one example embodiment, the label is either zero (indicative of no event/no leak) or one (indicative of event/leak). An example of such data set is below:

TABLE 1

| Timestamp | Metric | Value | Label |
|---|---|---|---|
| 1564589613 | Relative Flow Rate Difference | 0.011 | 0 |
| 1564589618 | Relative Flow Rate Difference | 0.012 | 0 |
| . . . | . . . | . . . | . . . |
| 1564589623 | Relative Flow Rate Difference | 0.340 | 1 |
| 1564589628 | Relative Flow Rate Difference | 0.356 | 1 |

In certain embodiments, the neural network model does not operate on each data point individually, but instead works with a set of data points. In some embodiments, the set of data points is a time sequences of 32-36 data points. In certain embodiments, this data set corresponds to 2-3 minutes of data. In other example embodiments, the data set may correspond to 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 minutes of data. In such an embodiment, the control unit converts the sequence of labels into a single label. As an example, assume that there is a sequence of 10 data points S=[0.011, 0.012, 0.014, 0.012, 0.015, 0.016, 0.230, 0.340, 0.440, 0.420]. In this example, labels for such a sequence would be L=[0, 0, 0, 0, 0, 0, 1, 1, 1, 1]. In order to generate a single label for a sequence we take an average of all labels for each data point:

$$p = \frac{1}{N} {\sum }_{i = 1}^{N} {LABEL}_{i} \qquad ( Eq . 1 )$$

Where N is a total number of points in a sequence (32 or 36). The term “p” is a probability of a leak event on a given timeframe. Each probability associated with timestamp—the maximum timestamp for a sequence of points, for example, the timestamp associated with the last data point in a sequence.

As a result, we get a dataset of sequences associated with labels—probabilities. An example of such a dataset is given in a table below:

TABLE 2

| Sequence | Probability label |
|---|---|
| [0.011, 0.012, 0.014, 0.012, 0.015, 0.016, | 0.4 |
| 0.230, 0.340, 0.440, 0.420] | |
| [0.290, 0.295, 0.300, 0.310, 0.315, 0.320, | 1 |
| 0.315, 0.340, 0.310, 0.310] | |
| [0.560, 0.530, 0.510, 0.500, 0.400, 0.200, | 0.6 |
| 0.001, 0.002, 0.004, 0.003] | |
| [0.001, 0.002, 0.004, 0.012, 0.005, 0.007, | 0 |
| 0.005, 0.007, 0.009, 0.003] | |
| . . . | |

The controller generates features for branch 1 of the model (block 1210). In this example embodiment, the dataset from table 2 is passed to branch 1 of the neural network model.

The controller generates features for branch 2 of the model (block 1215). Unlike the example branch 1 described above, where each data row is a sequence of numbers that related to each other (time series of relative flow rate difference values), features in branch 2 may not physically relate. Therefore features in branch 2 is just a collection of derived properties. Example properties that can be used as features in a branch 2 of neural network model, include, but are not limited to:
Average relative flow rate difference (RFRD) over a sequence:

$$\frac{1}{N} {{Σ}_{1}^{N} ( RFRD )}_{i} ;$$

Standard deviation of RFRD within a sequence;
Volume loss from RFRD (area under RFRD sequence);
Normalized inlet flow rate: inlet flow rate divided by scaling parameter (5000 for example);
Normalized outlet flow rate;
Total volume loss over the last M minutes, where M can be 1, 2, 3, 4, 5, 6, 7, 8, 9, 10, 15, 20, 23, 25, 30, 35, 40, 45, 50, 55, 60, 65, 70;
Number of negative RFRD points;
Number of positive RFRD points;
Number of RFRD points in a given range. Ranges can be [−1, −0.9], [−0.9, −0.8], [−0.8, −0.7], [−0.7, −0.6], [−0.6, −0.5], [−0.5, −0.4], [−0.4, −0.3], [−0.3, −0.2], [−0.2, −0.1], [−0.1, 0], [0, 0.1], [0.1, 0.2], [0.2, 0.3], [0.3, 0.4], [0.4, 0.5], [0.5, 0.6], [0.6, 0.7], [0.7, 0.8], [0.8, 0.9], [0.9, 1];
Median RFRD in a sequence;
Maximum RFRD in a sequence;
Minimum RFRD in a sequence; and
Ratio of number of positive RFRD values to a number of negative RFRD values within a sequence.

As a result, the controller generates values in the table below of new features that will be used for branch 2 training:

TABLE 3

| Feature 1 | Feature 2 | Feature 3 | . . . | Feature M | Probability label |
|---|---|---|---|---|---|
| 0.017 | 0.96 | −0.13 | . . . | 0.8 | 0.4 |
| −0.11 | 0.93 | 0.18 | | 0.1 | 1 |
| 0.14 | 0.92 | −0.04 | | 0.9 | 0.6 |
| −1.01 | 0.88 | 0.25 | | 0 | 0 |

The controller trains the model in block 1220. In one example embodiment, to train the machine learning model the dataset is split into 3 parts: training dataset (40%), validation dataset (20%), and test dataset (40%). Ratios 40:20:40 was chosen arbitrary and other example embodiments feature different splitting ratios can be used including 40:30:30, 40:40:20, 50:25:25, 50:30:20. Training and validation datasets are used in training procedure directly, while test dataset is required only for model evaluation. In certain embodiments, each machine learning model may require its own training parameters. Example parameters to train neural network mode include a batch size of 32. In other example embodiments, the batch size may be 8, 16, 48, 64, 128, 256. Other example training parameters include a number of epochs. In general, the number of “epochs” refers to how many times each entry in training dataset passed through backpropagation algorithm to optimize neural network's weights. In one example embodiment, 1000 epochs was the selected parameter. In certain example embodiments, the data entries were shuffled in each epoch. In other example embodiments, the data entries are not shuffled, or are shuffled less frequently. In certain example embodiments, after each epoch model the resulting weights were saved if validation score decreased. At the end of training procedure, this provides a model with lowest validation score. In certain example embodiments, one or more optimizers are used as part of the training. In one example embodiment, the following optimizer were used: Adam, Stochastic Gradient Descent (SGD). For SGD optimizer the following parameters were used:
learning rate 0.01, or 0.001
learning rate decay 1e-5, or 1e-6
Nesterov momentum: 0.9

In certain example embodiments, as an evaluation metric, the “Area under the Receiver Operating Characteristic Curve” was used, also known as ROC-AUC score.

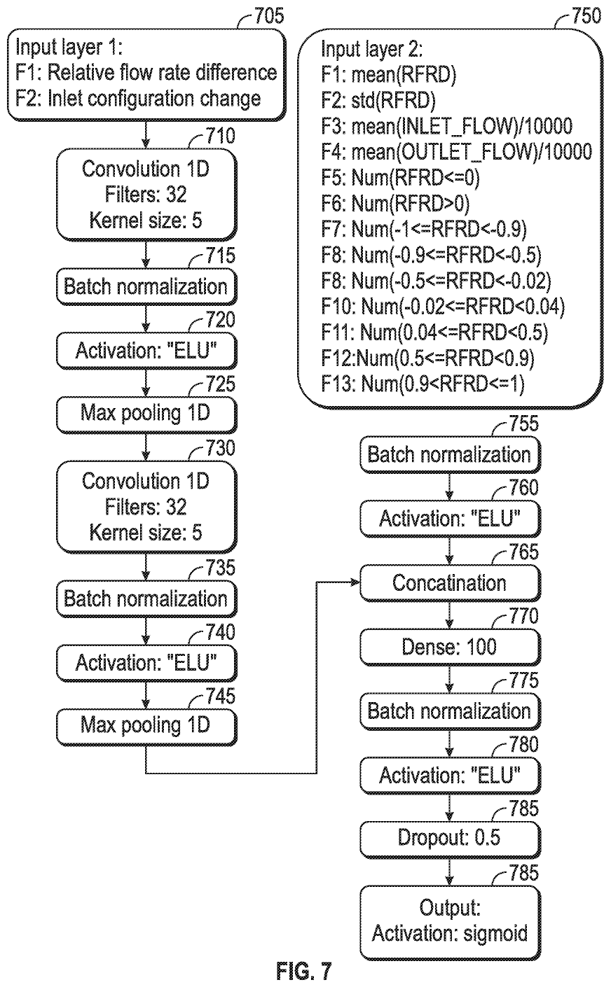

An example trained machine learning algorithm used by the decision-making service is shown in detail in FIG. 7. In general, the machine learning algorithm may have one, two, three, four, five, six, seven, eight, nine, ten, or more branches. Other example machine learning algorithms may have different architectures. The result of prediction can be either a single value probability that distinguish between event/no event states, or predict multiple probabilities for a plurality of possible events. Events may include, but are not limited to one or more of LEAK, MISCONFIGURATION, NORMAL FLOW, PIPELINE FILLING, and PIPELINE DRAINING. In certain example embodiments, the “LEAK” event result from either a mass or volumetric loss on the pipeline or flowline resulting in a release of fluids. In certain example embodiments, the “MISCONFIGURATION” event results from either missing inlet data that produces a higher outlet flow than inlet flow or an unexpected gain in the system balance from a node that should not be assigned to the system. In certain example embodiments, the normal “FLOW” event reflects a volume or mass balance behavior that is within the pipeline operator's expected gain or loss tolerance of the pipeline. In certain example embodiments, the “PIPELINE DRAIN” event results from a situation where the system has experienced some loss of volume through the outlet after all inlets have been disabled and stopped pushing fluid into the system. In certain example embodiments, the “PIPELINE FILL” event results after subsequent a drain scenario where inlets begin to push fluid to eliminate slack in the pipeline or alternatively when a pipeline is initially commissioned. Certain example embodiments use two, three, or more models to determine multiple probabilities for each event. The outputs of the multiple models may then be averaged to determine a final probability of the event.

The example artificial neural network shown in FIG. 7 is a two-branch convolutional neural network. In the first branch, at block 705, in one embodiment the control unit takes a relative flow rate difference and a scaled transition in number of active inlets as inputs and determines a relative flow rate difference (RFRD).

$$RFRD = \frac{{F}_{in} - {F}_{out}}{MAX ( {F}_{in} - {F}_{out} )} \qquad ( Eq . 2 )$$

In one example embodiment, the RFRD is determined for the last 32 data points. where F is a total flow on inlets (in) and outlets (out). In certain example embodiments, the RFRD metric is normalized in a [−1, 1] range. In one example embodiment, the controls system determines a logarithmic flow ratio (LFR).

$$LFR = ln \frac{{F}_{in} + 1}{{F}_{out} + 1} \qquad ( Eq . 3 )$$

In certain example embodiments, the control system normalizes the LFR values.

The control system then performs a convolution in block 710. With respect to the convolution, parameters are weights generated by the trained model based on given data using backpropagation algorithm. In certain embodiments, weights are selected by the training procedure to minimize the error. The resulting output is then batch normalized in block 715. The control system then performs an activation function at block 720. In one example embodiment, the ELU activation function is performed. Other example embodiments may use different activation functions, such as TANH, SOFTMAX, or RELU. Block 725 is a pooling layer that, in one embodiments, performs max pooling. Block 730 is a convolution layer. In one example embodiment, the filter size is 32 and the kernel size is 5. In other example embodiments, the kernel size is 3 or 7. In general however, the filter size may be between 1 and infinity. Block 735 is a batch normalization layer. In block 740, the control system performs an ELU activation function. In block 745, the control system performs a pooling layer.

In the second branch, at block 750, the control system determines thirteen input parameters. In other example embodiments, more, fewer, or different input parameters are determined. In one example embodiment, the control system determines a transient stage indicator. That is, if the number of active inlets increases with the next data point, then a value of 0.01 is assigned to the current data point. If the number of active inlets decreases with the next data point, then the control system assigns a scaling value of to the current data point. In certain example embodiments, the scaling parameters are 0, 0.01, or −0.01. In general, however, the scaling parameters may be any real number. If the number of inlets remains the same, then the control system assigns a value of 0 to the current data point. Other example embodiments may use different numbers for the transient stage analysis.

In block 750, the control system also determines a mean relative flow rate difference over the last 32 data points. The control system may also determine a standard deviation of the flow rate over the last 32 data points. The control system may also determine a total average inlet flow rate over the last 32 data points. In certain embodiments, this average inlet flow rate is normalized. The control system may also determine a total average outlet flow rate over the last 32 data points. In certain embodiments, this average outlet flow rate is normalized. In certain embodiments, the control system determines the relative number of data point in RFRD that are larger than 0. In certain embodiments, the control system determines the relative number of data point in RFRD that are smaller than 0. In certain embodiments, the control system determines the relative number of data point in RFRD that are in a range of [−1, −0.9). In certain embodiments, the control system determines the relative number of data point in RFRD that are in a range of [−0.9, −0.5). In certain embodiments, the control system determines the relative number of data point in RFRD that are in a range of [−0.5, −0.02). In certain embodiments, the control system determines the relative number of data point in RFRD that are in a range of [−0.02, 0.04). In certain example embodiments, the second branch takes derived features as inputs. Derived features include all features described above, and additionally one or more of cumulative flow rate, cumulative flow rate difference, normalized flow rate, standardized flow rate, deviations in active inlet count, and deviations in active outlet count. In block 755, the control system performs a batch normalization layer and in block 760, it performs an activation function layer. In one example embodiment, the block 760 activation is an ELU activation layer.

The control system concatenates the output of the two branches at block 765. The output of the concatenation is then subjected to a dense layer at block 770. The control system then performs a batch normalization at block 775, an activation layer at block 780, and a dropout layer at block 785. In example embodiments, different number of nodes can be used in dense layer. In certain example embodiments, the number of nodes is any integer value between 1 and infinity. In example embodiments, the number of nodes is between 10 and 1000. In example embodiments, the number of nodes is optimized by an external algorithm. In embodiments of the present system, dropout values may be any real value can be used between 0 and 1. The control system then performs an activation function at block 785 to generate an output. In one example embodiment, the activation function at block 785 is a sigmoid activation function.

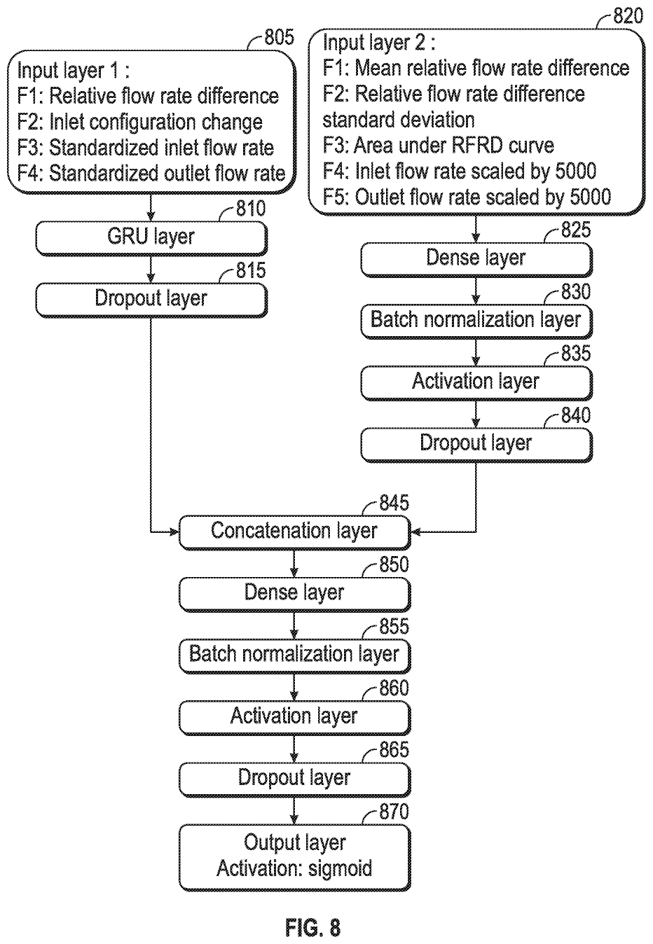

A second example machine learning algorithm used by the decision-making service is shown in detail in FIG. 8. In general, the machine learning algorithm may have one, two, three, four, five, six, seven, eight, nine, ten, or more branches. Other example machine learning algorithms may have different architectures. The result of prediction can be either a single value probability that distinguish between event/no event states, or predict multiple probabilities for a plurality of possible events. Events may include, but are not limited to, one or more of LEAK, MISCONFIGURATION, NORMAL FLOW, PIPELINE FILLING, and PIPELINE DRAINING. Certain example embodiments use two, three, or more models to determine multiple probabilities for each event. The outputs of the multiple models may then be averaged to determine a final probability of the event.

The first branch receives four inputs of relative flow rate difference, inlet configuration change, standardized inlet flow rate, and standardized outlet flow rate (block 805). the first branch then passes the inputs to a GRU (Gated Recurrent Unit) (block 810) and a dropout layer (block 815). In certain embodiments, the GRU is able to extract features from time series data more efficiently than the convolutional layers of the system of FIG. 7.

The second branch of the machine learning algorithm receives five inputs: a mean relative flow rate difference, a relative flow rate difference standard deviation, an area under RFRD curve, an inlet flow rate scaled by 5000, and an outlet flow rate scaled by 5000 (block 820). In general, the scaling parameters may vary in different implementations. In certain example embodiments, the scaling parameters are chosen so that all or most of the output values are between 0 and 1. The second branch further includes a dense layer (block 825), a batch normalization layer (block 830), an activation layer (block 835), and a dropout layer (block 840). The first and second branches are concatenated at concatenation layer (block 845). The combined branches are then though a dense layer (block 850), a batch normalization layer (block 855), an activation layer (block 860), a dropout layer (block 865), and an output layer (block 870).

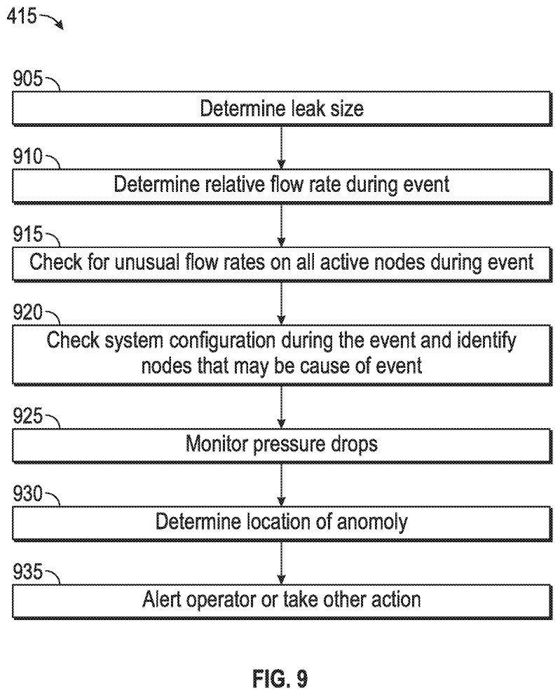

An example decision-making service (block 415) is show in FIG. 9. When an alarm is added by the prediction service (block 410), the control system determines what action to take. The control system may determine a leak size (block 905). For example, if the leak is less than a threshold amount, the control system may not notify a human. The control system determines a relative flow rate during the event (block 910). For example, a human may not be notified if the relative event flow rate is below a threshold. In certain embodiments, the control system checks for unusual flow rate on all active nodes during the event (block 915). In certain embodiments, the control system checks system configuration during the event and identifies nodes that may be the source of the event based on mis-configuration (block 920). In certain embodiments where pressures are available, the control system may monitor pressure drops during the event (block 925). In certain example embodiments, the controls system may determine the location of the anomaly (block 930). In certain embodiments, the control system may use outputs from acoustic, vibration, or visual sensors to determine the location of the anomaly. The control system may alert a human of the alarm or take other action (block 935).

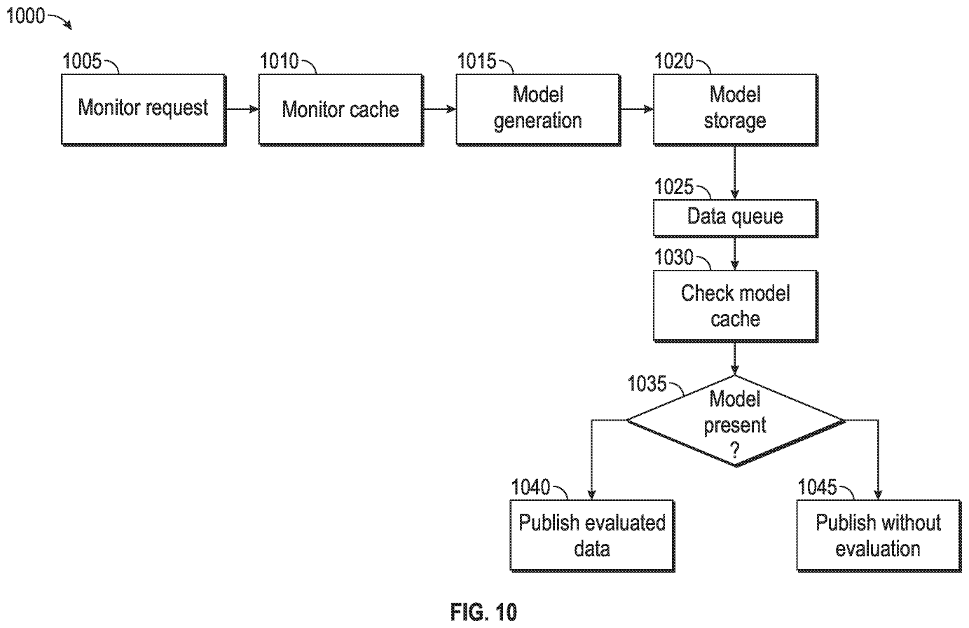

FIG. 10 is a block diagram of a method of anomaly detection for a pipeline or flowline. The system issues a monitor request to receive values from sensors monitoring aspect of the pipeline or flowline (block 1005). In certain example embodiments, the sensors include one or more of pressure sensors, flow-rate sensors, acoustic sensors, visible light or infrared sensors, and one or more other sensors. In certain embodiments, the monitor request is made at regular intervals of 1 second, 5 seconds, 10 seconds, 15 seconds, 30 seconds, 45 seconds, or one minute. Example monitor requests include one or more parameters.

Values from the sensors are cached (block 1010). The cached sensor values may be used to generate a model (block 1015). The resulting model may be cached (block 1020). With respect to detecting an anomaly, the system receives data from the monitor requests into one or more data queues (block 1025). The system determines if a model is present in the model cache (block 1035) and, if a model is present then the system publishes evaluated data using the cached model (block 1040). If, however, the system determines that no model is present (block 1035), then the system publishes the data without evaluation (block 1045).

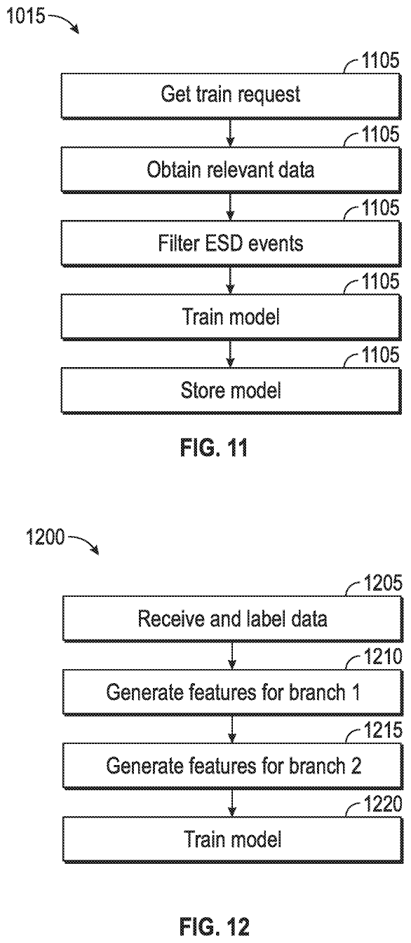

An example of model generation (block 1015) is shown in greater detail in FIG. 11. In block 1105, the system receives a train request to train a model (block 1105). The system then obtains relevant data for training (block 1105). In certain example embodiments, the system training is for a fixed-size window of data. In certain example embodiments, the window begins 30 days before the train request and ends at least one day before the train request. In one or more example embodiments, considerations for choosing the window are related to one or more of the decline state of the well, offset pressure variation by reservoir communication, well re-stimulation (for example, re-fracturing), well maintenance procedures like hot oil treatment and wireline operations (for example, downhole variations), changes of artificial lift type, artificial lift equipment, or modifications to artificial lift settings, or changes to wellhead backpressure valves. For example, older data may be excluded from the model so that the model reflects current operating parameters of the flowline being monitored.

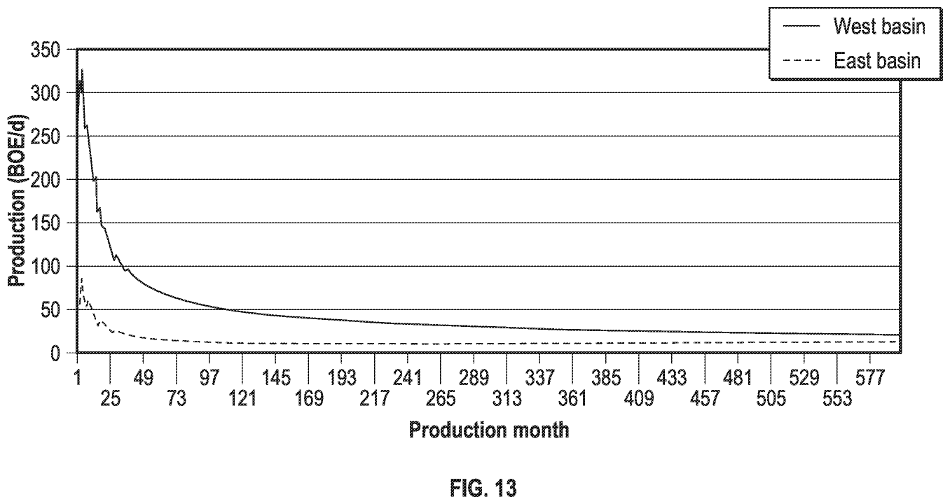

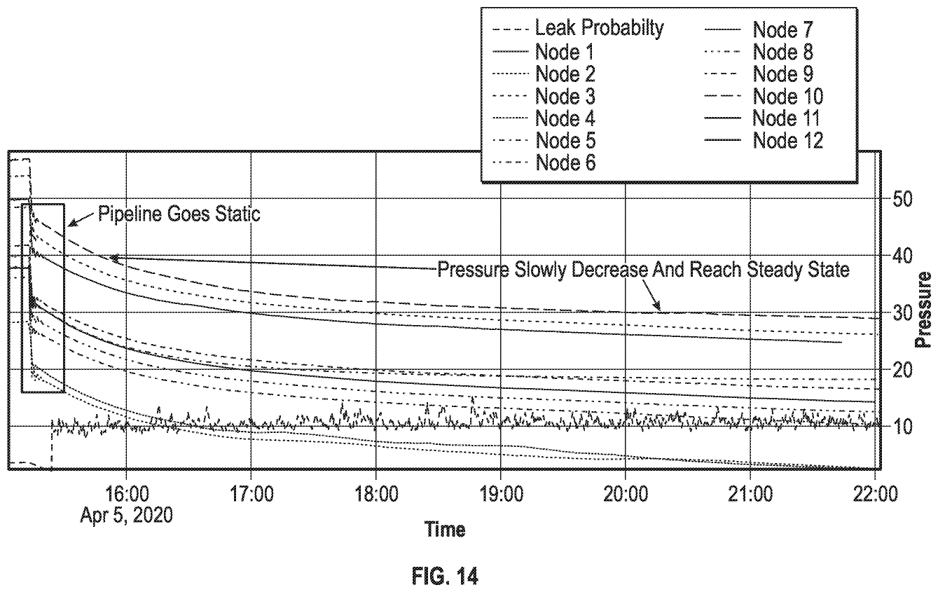

In certain example embodiments, the controls system normalizes data relative to the decline curve of the well as well. An example decline curve of a well is shown in FIG. 13. Decline curves generally show decline in production of a well, however within a flow regime and similar equipment, production is correlated to flowline pressure. In certain example embodiments, “decline curve” refers to the decline of pressure within a single flow regime, using the same equipment. Taking into account the pressure decline of a well would allow the controls system to consider larger periods of time when building a model, and even over shorter periods of time make the model more accurate.

The decline curve of FIG. 13 shows production versus time. In general, production is correlated with pressure in the flowline, assuming no equipment has changed. In example embodiments, a type curve could be fit to pressure data. The control system may then normalize the pressure data to the type curve so that the zero intersect for the pressure going backwards is along the decline curve. In example embodiments, the decline curve may the calculated used different procedures. In example embodiments, the decline curves could be parametric, such as an exponential function or a number of other equations. In example embodiments, the decline curve may be generate using a nonparametric approach, such as by the use of superposition time.

In example embodiments, over a small enough window in which the well is not declining steeply, the decline curve can be approximated to a line. In example embodiments, the control system determines the mean value at each point along the decline, using a rolling window, and take the resulting points to be the decline curve.

In certain embodiments, the control system subtracts the expected decline of pressure from the data, resulting in a pressure vs time plot where the pressure is distributed around 0 PSI. In certain embodiments, the control system ensures that the data has a standard deviation of 1. In example embodiments, the control system ensures that the data has the expected standard deviation by using the standard deviation of the pressure throughout the entire window being considered. However, because the data might be distributed differently at different points in the well's decline—for example, some parts of a flow regime might be more turbulent than others, the control system may get a measure of standard deviations at various times throughout the window being considered and normalize based on the changing standard deviation. In example embodiments, the controls system performs a windowed average standard deviation

xₙₒᵣₘ=(x_{actual}−x_{expectedDeclineValue})/σ_{standardDeviationForDataPoint} (Eq. 4)

In this example, the control system would analyze data when equipment changes have not been made that would affect the flowline pressure behavior.

In example embodiments, ore recent data may be excluded from model training so that the system has time to collect data from sensors that may lag other sensors. The system filter ESD events before training the model (block 1105). ESD events will vary based on the sensors used. In example embodiments, “ESD events” refers to an electronic signal given by one or more sensors in the field to indicate that it is reading some sort of value that warrants starting an emergency shut-down procedure, or an emergency shut down has manually been initiated by a stakeholder. In example embodiments, the control system also filters other non-emergency shut downs, which aren't sent in the ESD signal from the field. Planned shutdown events could happen for a number of reasons such as planned maintenance, equipment switches, or offset-frac jobs. In certain embodiments, the control system recognizes these events by looking for oil/gas production values close to 0 that span a period of time. In certain embodiments, the control system recognizes the events by seeing if the well is shut in.

Example ESD events include one or more of treater level switch, treater pressure above a treater pressure threshold, large blow case, small blow case, fire tube, KO drum switch, flowline hi pressure, flare status, water tank high level, level ESD, oil tank heights, battery voltage, separator communication down, tank communication down, combustor communication down, wellhead communication down, bath temp, treater temp, VRT high level switch, VRT scrubber switch, VRU fault, power fail, sales line hi PSI, group water tank high level, group oil tank high level, Low Line pressure, High Line pressure, High Level in production separator, High Level in water tank, High Level in sand box, High Pipeline Pressure.

In example embodiments, the events may be organized by sensor type. With respect to pressure transducers, events may include high pressure and low pressure. In example embodiments, the pressure transducer high pressure event may reflect one or more of high casing, tubing, flowline, high pressure separator, wellhead, flare-line, etc. pressures. In example embodiments, the pressure transducer low pressure event may reflect one or more of low casing, tubing, flowline, high pressure separator, wellhead, flare-line, etc. pressures. Events related to a temperature transducer may include high wellhead, flowline, high pressure separator, etc. temperatures. Events related to communication issues may include one or more of separator, combustor, tank, wellhead, etc. communication down. Events related to material management sensors, including radar or tuning fork sensors may one or more of high oil tank level, high water tank level, high pressure separator level, high level in sandbox, etc. Events related to equipment failures may include one or more of pump failure, compressor failure, etc. Events related to electrical failure may include one or more of low battery level, power failure. Other events may include high H2S level, scheduled shut-in, etc.

The system then trains the model in block 1105. Example of model training include generating a plurality of kernel density estimation models. The system then tests the kernel density estimation models to determine the best model. The testing may include recursive gradient descent to find the highest log-likelihood for selected model. The model training may further include scaling the chosen model. Example implementations of model training may include one or more hyper parameter optimizations. Example hyper parameter optimizations include brute force optimization, such as grid search, random search, or random parameter optimization. In random search, the control system leaves out or puts in random parameters for various cases. By using random search the control system may not have to look at as many cases, so it saves on computational resources. In certain embodiments, random search may result in a sub-optimal model when compared to grid search, which is exhaustive.

Example implementations of model training may include one or more model specific cross-validation techniques such as ElasticNetCV, LarsCV, LassoCV, LassoLarsCV, LogisticRegressionCV, MultiTaskLassoCV, OrthogonalMatchingPursuitCV, RidgeCV, or RidgeClassifierCV. Example implementations of model training may include one or more out of bag estimates. Some ensemble models—which are models that use groups of other models to make predictions, like random forest which uses a multitude of tree models—use bagging. Bagging is a method by which new training sets are generated by sampling with replacement, while part of the training set remains unused. For each classifier or regression in the ensemble, a different part of the training set would be left out. The left-out portion can be used to estimate how accurate the models are without having a separate validation set, which would make the estimate come “for free” because in other training processes, cross validation requires losing data could be used for model training.

Example Models that use out of bag estimations include Random Forest Classification, Random Forest Regression, Gradient Boost Classifier, Gradient Boost Regression, Extra-Tree Classifier, and Extra-Tree Regression.

In example embodiments, the kernel density estimation is for one stream. In other example embodiments, the kernel density estimate trains on two or more streams. Where the kernel density estimation trains on multiple streams, the control stem pulls data streams from one or more databases. In example embodiments, the data table is pivoted, such that the time stamp is the index and the metric names are the columns. In example embodiments, null values are filled in using either interpolation, single variate imputation, multi variate imputation, or other methods. In example embodiments with multiple streams, the training process proceeds as it would after, doing hyper-parameter optimization (such as grid search), etc.

In example embodiments, when it comes to caching the model (or otherwise saving it), the model would be given a unique id. The model would be cached with the key being the unique ID, and the model itself being the value. In example embodiments, each data stream the model relied on would be cached as well. With the key being the name of the data stream, and the value being a list of all unique model ids associated with that data stream. In example embodiments, when a data message comes in we first check the cache that contains the keys as the specific data stream name, and the keys as a list or set of all unique models associated with that data stream. If no models are found, then nothing is done. If models are found, the control system runs each model. If the model needs more than one data stream it can check the cache generated by the “new process.” In example embodiments, the model can be called through a number of ways, not just triggered by an incoming data message, but by it being on a timer, a user calling it to run, or any multitude of ways. In example embodiments, the saving of data can be handled by a process that saves it to a database, or wherever else, in which case when a process is triggered to run the model, it will reference wherever that data is stored. In example embodiments, instead of storing the data, the control system may poll equipment to get the latest sensor readings for the model to run.

In random search, the control system leaves out or puts in random parameters for various cases. By using random search, the control system may not have to look at as many cases, so it saves on computational resources. In certain embodiments, random search may result in a sub-optimal model when compared to grid search, which is exhaustive.

Example Models that use out of bag estimations include Random Forest Classification, Random Forest Regression, Gradient Boost Classifier, Gradient Boost Regression, Extra-Tree Classifier, and Extra-Tree Regression.

After the model is chosen, in example embodiments, the chosen model is stored (block 1105). In certain embodiments, the storage is performed by caching. In example embodiments, after the model is chosen, the model is stored along with metadata about the model. The metadata is used when the model is called. The metadata can also be used to as information as to how to route incoming requests to the appropriate models.

In certain example embodiments, the system performs an analysis of static fluids in pipelines or flowlines. FIG. 13 is a chart of node pressures versus time for a static pipeline. In general, as shown in FIG. 1131, when the pipeline transitions to a static mode, the flow stops and pressure begins to drop at all of the nodes. The node pressures then oscillate for a few minutes. This oscillation is shown by sinusoidal patters in the beginning of the static pressure trends. The oscillations then dampen and disappear after a few minutes in the static regime. The behavior in FIG. 11 is the expected pipeline behavior in the static regime. If, however, there is a significant drop in pressure in as short time period, then there may be a leak or anomaly that should be detected. In certain example embodiments, a significant pressure drop may be more than 0.5 psi, more than 1 psi, more than 2 psi, more than 3 psi, more than 4 psi, or more than 5 psi. The pressure drop may be over a period of more than 10 second, 20 second, 30 second, 40 second, 50 second, 60 second, 70 second, 80 second, 90 second, 100 second, 110 seconds 120 seconds, 130 seconds, 140 second, 150 second, 160 seconds, 170 seconds, 180 seconds, 190 seconds, 200 seconds, 210 seconds, 220 seconds, 230 seconds, or 240 seconds.

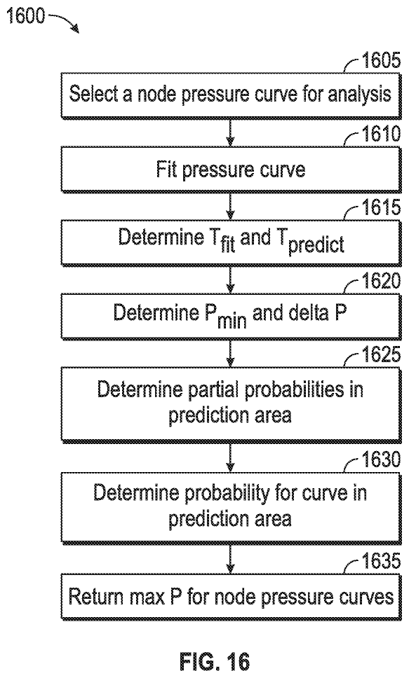

FIG. 16 is a flowchart of an example method for monitoring pressures in a static pipeline or flowline and detecting leaks or anomalies in the pipeline or flowline. In block 1605 the system selects a single pressure curve from the plurality of pressures measured in the pipeline or flowline. In certain embodiments, the system will repeat the procedure of FIG. 16 on two or more pressure node curves. The pressure curve may be designated Yⁱ, where i∈[1, . . . , N] where N is the total number of nodes that generate pressure data.

In block 1610, the system fits a pressure curve over the period T_{fit}. In certain example embodiments, the pressure fit curve is hyperbolic. In other example embodiments, the curve is linear. In some example embodiments the pressure curve is the largest absolute deviation of actual data from linear fit as defined by the function:

∂y_{fit}ⁱ=s*max(|yₖⁱ−yₖ⁻ⁱ|),k∈[1, . . . ,T_{fit}] (Eq. 5)

In block 1615, the system determines how much data will be used for fitting the curve and then how much data will be used for prediction of an anomaly. In certain example embodiments, the fitting time is referred to as T_{fit} and the length of the prediction period is T_{predict}. In certain example embodiments, the value of T_{fit} can be any positive value. In certain example embodiments, T_{fit} is an index, and therefore must be integer, but greater than 1. In certain example embodiments, T_{fit} is chosen empirically based on one or more of frequency of data, meter accuracy, and presence of false alarms. For example these system receives data points every 5 seconds, and accuracy is good, T_{fit} may vary between 10 and 60, which roughly correspond to 1-5 minutes of data. This is enough to make a prediction. In example embodiments, T_{fit} is 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100.

In block 1620, the system determines a minimum pressure drop parameter pₘᵢₙ for which the system should not label such a pressure change as an anomaly. In certain example embodiments, there will be oscillation that are larger than pₘᵢₙ, but example system will not label such oscillation changes as anomalies because such oscillations are normal, as discussed above with respect to FIG. 13. To avoid false alarms, the system adjusts the pₘᵢₙ parameter by selecting the largest value between pₘᵢₙ and ∂y_{fit}ⁱ.

∂p=max(pₘᵢₙ,∂y_{fit}ⁱ) (Eq. 6)

In block 1625, the system determines the difference between the predicted pressures and the measured pressures in the prediction region. In one example embodiment, the system extrapolates the line Ŷⁱ into the prediction region to find the difference between the predicted pressures. In example embodiments, the system, for each difference determines a value of partial probability as:

$${p}_{j}^{i} = \frac{1}{1 + {e}^{- \frac{( \partial {y}_{j}^{i} - \partial p )}{σ}}} \qquad ( Eq . 7 )$$

where σ is a smoothing parameter and ∂yⱼⁱ=yⱼⁱ−ŷⱼⁱ is a difference between observed pressure and predicted pressure at a point j for a curve i. The indices j are valid for a prediction segment and start at the left part of the prediction segment. Thereafter the system has calculated partial probabilities for each point within the prediction segment. In certain embodiments, the value of the σ smoothing parameter is chosen to prevent probability spiking. In certain embodiments, the σ smoothing parameter is any positive floating point value from range (0, +inf). In certain embodiments, the σ smoothing parameter is a value from range (0, 10] such that it prevents probability spiking and false alarms. In certain embodiments, the σ smoothing parameter is 0.1, 0.2, 0.5, 1.0, 2.0, 5.0, 10, or intermediate values.

In block 1630, the system determines a probability for the curve i. In one example embodiment, the probability for the curve i is calculated as:

$${p}^{i} = \frac{{\sum }_{j = 1}^{{T}_{predict}} {p}_{j}^{i} * {e}^{- ( {T}_{predict} - j ) \text{/} {T}_{predict}}}{{\sum }_{j = 1}^{{T}_{predict}} {e}^{- ( {T}_{predict} - j ) \text{/} {T}_{predict}}} \qquad ( Eq . 8 )$$

where

$${e}^{- \frac{{T}_{predict} - j}{{T}_{predict}}} = {w}_{j}^{i}$$

is a weight of the j-th probability. In example embodiments the weights are chosen to minimize the influence of a partial (j-th) probability on the total probability value. In example embodiments the weights are chosen the weights can be set to be equal to each other. In example embodiments the weights are assigned weights as e^{-(T}^{_{predict}}^{-j)/T}^{_{predict}}. In example embodiments the parameter T_{predict} is selected empirically based on one or more of data frequency, meter accuracy, and to minimize number of false alarms.

Weights are something that everyone can easily play with. There are no restrictions on how those weights must be assigned. We have chosen them to be calculated according to exp(*) formula, however someone else may decide that all the weights must be equal to 1. It is impossible to predict how this affect the final result. At the same time, there is no difference between setting weights to 1, and to 20, because the total probability will be normalized anyway.

I think it is worth saying that weights can be set equal to each other. In certain example embodiments, the most recent pressure point has the largest index T_{predict} and therefore the largest corresponding weight (1). In example embodiments, the oldest point with index 1 has weight

$${e}^{- \frac{{T}_{predict} - 1}{{T}_{predict}}} .$$

If we assume that one minute of 5 second data is used to make a prediction, the T_{predict}=12 and wⱼⁱ≈0.4.

The process of block 1605-1630 is repeated for each of the node pressure curves. In block 1635, the system determines which of the pressure curves returns the largest probably.

$$p = {max}_{1 \leq i \leq N} {p}^{i} \qquad ( Eq . 9 )$$

In other example embodiments, the system returns probabilities for two, three, four, five, six, seven, eight, nine, ten, or all pressure curves.

In certain example embodiments, the process of FIG. 16 is modified by one or more model parameters. Example model parameters include one or more of.
s [STATIC MODEL SENSITIVITY]—In certain example embodiments, this parameter scales model's sensitivity. The larger it is the less sensitive a model;
[STATIC MODEL IGNORE BEGINNING SEC] In certain example embodiments the first few minutes of pressure data remains quite unstable after pipeline shutdown. Because of that static model may trigger false alarm. To avoid that we can ignore first few minutes of data and to not generate a prediction on them;
[STATIC MODEL MIN PRESSURE PSI] In certain example embodiments, the system will not make a prediction on nodes if their absolute pressure is below that threshold;
[STATIC MODEL EXCLUDED NODES]—In certain example embodiments the system exclude nodes from prediction. The exclusion may be made by a primo ID;
[STATIC MODEL FORCE ALARM]—In certain example embodiments, the system forces a model to trigger an alarm if warning have been triggered;
[STATIC MODEL NAME]—In certain example embodiments, each model has its own name, and we distinguish between different models by their names. Name may be a simple alphanumeric sequence that can uniquely identify a model.

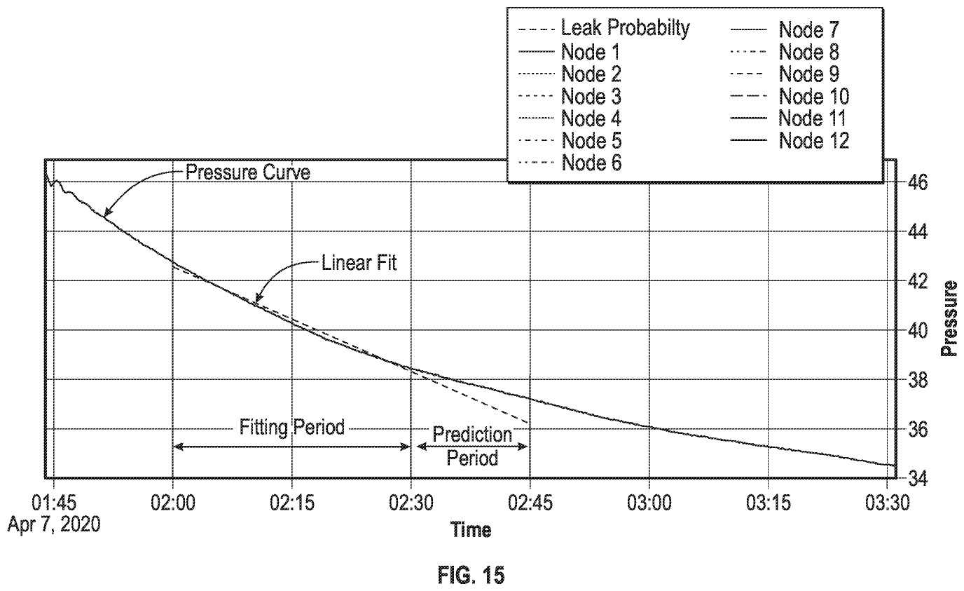

FIG. 15 is a chart of a single node pressure curve versus time. The chart shows the fitting period T_{fit} and prediction period T_{predict}. The chart further shows the liner fit to the pressure curve.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

A number of examples have been described. Nevertheless, it will be understood that various modifications can be made. Accordingly, other implementations are within the scope of the following claims.

What is claimed is:

1. A method for detecting an anomaly in a pipeline or a flowline, the method comprising:
monitoring real-time data in the pipeline or the flowline, wherein the pipeline or flowline includes a plurality of nodes, the nodes including at least one or more inlets and one or more outlets;
generating a probability metric using a prediction service, wherein the prediction service uses a convolutional neural network;
determining whether to add an alarm, based, at least in part on the probability metric; and
if there are one or more active alarms, performing an action based on the active alarm.

2. The method of claim 1, wherein the real-time data in the pipeline or the flowline includes one or more of pressures, flow rates, temperatures, acoustics, and visual data.

3. The method of claim 1, wherein the prediction service uses a machine learning algorithm.

4. The method of claim 3, wherein the machine learn algorithm is a multi-branch artificial neural network.

5. The method of claim 4, wherein a first branch of the two-branch neural network includes a plurality of first features and wherein a first branch of the two-branch neural network includes a plurality of second features.

6. The method of claim 3, wherein the first branch of the convolutional neural network includes one more of mass volume and relative flow rate difference.

7. The method of claim 3, wherein the first branch of the convolutional neural network includes

8. The method of claim 1, wherein monitoring flowrates in the pipeline or the flowline includes one or more of:
determining an inlet flow rate as a sum of active inlets in the pipeline or flowline;
determining a standard flow rate as a sum of standard flow rates of active inlets in the pipeline or flowline;
determining an outlet flow rate as a sum of flow rates from active outlets in the pipeline or flowline;
generating an active inlets list;
generating an active outlets list;
determining a relative flow rate difference; and
determining a standard relative flow rate difference.

9. The method of claim 1, wherein the determination to add an alarm is based on one or more of:
a size of a detected leak in the pipeline or flowline;
a location of the detected leak in the pipeline or flowline;
a relative flow rate during the event;
whether there are anomalous flow rates on active nodes;
a change in system configuration; and
one or more pressure drops detected during the event.

10. A method for detecting anomaly in a pipeline or a flowline, the method comprising:
monitoring a plurality of nodes in the pipeline or the flowline;
receiving data from the plurality of nodes in the pipeline or the flowline;
for each of the cleaning the received data from the plurality of nodes in the pipeline or the flowline to generated cleaned data; and
training an anomaly detection model using the cleaned data.

11. The method of claim 10, wherein training an anomaly detection model using the cleaned data includes performing at least one kernel density estimation.

12. The method of claim 10, wherein training an anomaly detection model using the cleaned data comprises:
receiving a train request including a plurality of paraments that specify:
a data stream to train on;
a time from over which to train;
how often to retrain the model; and
one or more thresholds for generating an alarm.

13. The method of claim 10, wherein training an anomaly detection model includes:
receiving a plurality of cleaned data;
standardizing the cleaned data;
generating a plurality of candidate kernel density estimation models; and
evaluating the plurality of candidate kernel density estimation models using a grid search to determine a chosen model.

14. The method of claim 13, wherein generating a plurality of candidate models comprises varying a bandwidth of each of the candidate models around Silverman's rule.

15. The method of claim 13, further comprising caching the chosen model in a model cache.

16. The method of claim 15, further comprising:
determining whether a model is present for the data from the plurality of nodes in the pipeline or the flowline;
if a model is not present, publishing the data from the plurality of nodes in the pipeline or the flowline without evaluation; and
if a model is present, publishing the data from the plurality of nodes in the pipeline or the flowline with evaluation.

17. The method of claim 10, wherein monitoring a plurality of nodes in the pipeline or the flowline includes monitoring real-time data in the pipeline or the flowline includes one or more of pressures, flow rates, temperatures, acoustics, and visual data.

18. A system for detecting anomaly in a pipeline or a flowline, the system comprising:
one or more sensors;
one or more processors;
a memory including non-transitory executable instructions that, when executed cause the one or more processors to:
monitor real-time data in the pipeline or the flowline, wherein the pipeline or flowline includes a plurality of nodes, the nodes including at least one or more inlets and one or more outlets;
generate a probability metric using a prediction service, wherein the prediction service uses a convolutional neural network;
determine whether to add an alarm, based, at least in part on the probability metric; and
if there are one or more active alarms, perform an action based on the active alarm.

19. The system of claim 18, wherein the real-time data in the pipeline or the flowline includes one or more of pressures, flow rates, temperatures, acoustics, and visual data.

20. The system of claim 18, wherein the prediction service uses a machine learning algorithm.
